(19) United States
(12) Patent Application Publication
(10) Pub. No.: US 2016/0212593 A1
(43) Pub. Date: Jul. 21, 2016

(54) INFORMATION PROCESSING SYSTEM, RELAY APPARATUS, INFORMATION PROCESSING APPARATUS, PROGRAM, AND INFORMATION PROCESSING METHOD

(71) Applicant: NEC CORPORATION, Tokyo (JP)

(72) Inventors: Shinji Masuda, Tokyo (JP); Tomonori Kumagai, Tokyo (JP)

(73) Assignee: NEC CORPORATION, Tokyo (JP)

(21) Appl. No.: 14/912,978

(22) PCT Filed: Jul. 30, 2014
(86) PCT No.: PCT/JP2014/070096

§ 371 Date: Feb. 19, 2016

(30) Foreign Application Priority Data
Aug. 28, 2013 (JP) 2013-176959

(51) Int. Cl. H04W 4/04; H04W 4/02; H04W 4/00

(52) U.S. Cl. CPC H04W 4/046; H04W 4/008; H04W 4/028; H04W 84/047

(57) ABSTRACT

A relay apparatus includes a first and second communication units. The first communication unit repeatedly attempts communication with portable communication terminals located in a communication range of the relay apparatus, and receives, from each of the portable communication terminals with which communication is established, terminal identification information for identifying each of the portable communication terminal. The second communication unit transmits moving object identification information to an information processing apparatus as in-range information along with the terminal identification information received by the first communication unit whenever the first communication unit attempts communication. The information processing apparatus includes an in-range information storage unit and an update unit. The in-range information storage unit stores the in-range information received from the second communication unit of the relay apparatus. The update unit updates the terminal identification information stored in the in-range information storage unit whenever new in-range information is received from the second communication unit.

### TECHNICAL FIELD

The present invention relates to an information processing system, a relay apparatus, an information processing apparatus, a program, and an information processing method.

### BACKGROUND ART

Development of techniques of transmitting appropriate information to a portable communication terminal of a user at an appropriate timing has recently progressed. As one of the techniques, there is a technique of providing information in accordance with a destination when a user has moved by vehicle.

For example, Patent Document 1 discloses a system in which advertisement information has been transmitted to an on-vehicle navigation device, and the on-vehicle navigation device transmits the advertisement information to a portable navigation device of a user when detecting that the user gets out of the vehicle. In the system disclosed in Patent Document 1, it is determined that the user gets out of the vehicle in a case where a door of the vehicle is locked, the door is closed, an engine is stopped, or an ignition key is at an off position.

In addition, Patent Document 2 discloses a system in which position information calculated by a navigation device installed in a vehicle is transmitted to a portable terminal of a user, and the position information is transmitted from the portable terminal to a server as position information of the portable terminal. The server provides a service on the basis of the position information received from the portable terminal.

### RELATED DOCUMENT

### Patent Document

[Patent Document 1] Japanese Unexamined Patent Application Publication No. 2006-133141

[Patent Document 2] Japanese Unexamined Patent Application Publication No. 2013-122694

### SUMMARY OF THE INVENTION

### Technical Problem

The present inventor has made investigation on providing appropriate information at appropriate timing to people who move by using a moving object which many unspecified people ride, such as a bus or an electric train. In order to achieve this, it is considered that people who get on/off a moving object are required to be specified.

An object of the present invention is to provide an information processing system, a relay apparatus, an information processing apparatus, a program, and an information processing method, capable of specifying a person who gets on/off a moving object.

### Solution to Problem

According to an aspect of the present invention, there is provided an information processing system including a relay apparatus that is installed in a moving object gotten on/off by a person and that performs communication with portable communication terminals; and an information processing apparatus that performs communication with the relay apparatus, in which the relay apparatus includes a first communication unit that repeatedly attempts communication with the portable communication terminals located in a communication range of the relay apparatus, and receives, from each of the portable communication terminals with which communication is established, terminal identification information for identifying each of the portable communication terminal; and a second communication unit that transmits moving object identification information for identifying the relay apparatus or the moving object, and the terminal identification information received by the first communication unit, to the information processing apparatus as in-range information whenever the first communication unit attempts communication, and in which the information processing apparatus includes an in-range information storage unit that stores the in-range information received from the second communication unit; and an update unit that updates the terminal identification information stored in the in-range information storage unit whenever new in-range information is received from the second communication unit.

According to another aspect of the present invention, there is provided a relay apparatus which is installed in a moving object gotten on/off by a person and which performs communication with portable communication terminals, the apparatus including a first communication unit that repeatedly attempts communication with the portable communication terminals located in a communication range of the relay apparatus, and receives, from each of the portable communication terminals with which communication is established, terminal identification information for identifying each of the portable communication terminals; and a second communication unit that transmits moving object identification information for identifying the relay apparatus or the moving object, and the terminal identification information received by the first communication unit, to the information processing apparatus as in-range information whenever the first communication unit attempts communication.

According to still another aspect of the present invention, there is provided an information processing apparatus communicating with a relay apparatus which is installed in a moving object gotten on/off by a person and which performs communication with portable communication terminals, the information processing apparatus including an in-range information storage unit that stores moving object identification information for identifying the relay apparatus or the moving object, and terminal identification information received by the relay apparatus from the portable communication terminal, as in-range information; and an update unit that receives new in-range information from the relay apparatus, and updates the terminal identification information stored in the in-range information storage unit whenever the in-range information is received.

According to still another aspect of the present invention, there is provided a program used for a relay apparatus which is installed in a moving object gotten on/off by a person and which performs communication with portable communication terminals, the program causing the relay apparatus to have a first communication function of repeatedly attempting communication with the portable communication terminals located in a communication range of the relay apparatus, and receiving, from each of the portable communication terminals with which communication is established, terminal identification information for identifying each of the portable communication terminals; and a second communication function of transmitting moving object identification information for identifying the relay apparatus or the moving object, and the terminal identification information received by using the first communication function, to the information processing apparatus as in-range information, whenever the relay apparatus attempts communication by using the first communication function.

According to the present invention, there is provided a program used for an information processing apparatus communicating with a relay apparatus which is installed in a moving object gotten on/off by a person and which performs communication with portable communication terminals, the program causing the information processing apparatus to have an in-range information storage function of storing moving object identification information for identifying the relay apparatus or the moving object, and terminal identification information received by the relay apparatus from the portable communication terminal, as in-range information; and an update function of receiving new in-range information from the relay apparatus, and updating the terminal identification information stored by using the in-range information storage function whenever the in-range information is received.

According to still another aspect of the present invention, there is provided an information processing method using a relay apparatus that is installed in a moving object gotten on/off by a person and that performs communication with portable communication terminals; and an information processing apparatus that performs communication with the relay apparatus, in which the relay apparatus repeatedly attempts communication with the portable communication terminals located in a communication range of the relay apparatus, and receives, from each of the portable communication terminals with which communication is established, terminal identification information for identifying each of the portable communication terminals, and transmits the received terminal identification information to the information processing apparatus as in-range information along with moving object identification information for identifying the relay apparatus or the moving object, and in which the information processing apparatus stores the in-range information received from the relay apparatus, and updates the stored terminal identification information whenever new in-range information is received from the relay apparatus.

### Advantageous Effects of Invention

According to the present invention, it is possible to specify a person who gets on/off a moving object.

### BRIEF DESCRIPTION OF THE DRAWINGS

The above-described object, and other objects, features and advantages will become more apparent from preferred exemplary embodiments described below and the following drawings accompanying the exemplary embodiments.

FIG. 1 is a diagram illustrating a configuration of an information processing system according to a first exemplary embodiment.

FIG. 2 is a block diagram illustrating a functional configuration of a relay apparatus.

FIG. 3 is a block diagram illustrating a functional configuration of an information processing apparatus.

FIG. 4 is a diagram illustrating an example of data stored in an in-range information storage unit in table form.

FIG. 5 is a flowchart illustrating an example of operations performed by the relay apparatus and the information processing apparatus.

FIG. 6 is a diagram illustrating a configuration of an information processing system according to a second exemplary embodiment.

FIG. 7 is a block diagram illustrating an example of a functional configuration of a position information generation unit.

FIG. 8 is a block diagram illustrating a functional configuration of an information processing apparatus.

FIG. 9 is a diagram illustrating an example of data stored in an address storage unit in table form.

FIG. 10 is a diagram illustrating an example of data stored in a position information storage unit in table form.

FIG. 11 is a diagram illustrating an example of data stored in a provision information storage unit in table form.

FIG. 12 is a flowchart illustrating an example of operations performed by a relay apparatus and the information processing apparatus according to the present exemplary embodiment.

FIG. 13 is a diagram illustrating a configuration of an information processing system according to a third exemplary embodiment.

FIG. 14 is a diagram illustrating a configuration of an information processing system according to a fourth exemplary embodiment.

FIG. 15 is a block diagram illustrating a functional configuration of a position information generation unit according to a fifth exemplary embodiment.

FIG. 16 is a block diagram illustrating a functional configuration of an information processing apparatus according to the fifth exemplary embodiment.

FIG. 17 is a diagram illustrating an example of data stored in a conversion information storage unit in table form.

### DESCRIPTION OF EXEMPLARY EMBODIMENTS

Hereinafter, exemplary embodiments of the present invention will be described with reference to the drawings. In addition, the same constituent elements are given the same reference numerals throughout all the drawings, and description thereof will not be repeated.

In addition, in the following description, each constituent element of each apparatus indicates not a configuration in the hardware unit but a configuration in the function unit. Each constituent element of each apparatus is realized by combinations of hardware and software including a CPU, a memory, a program loaded to the memory, a storage medium such as a hard disk storing the program, and an interface for connection to a network of any computer. Further, there are various modification examples in methods and apparatuses for realizing each constituent element.

### First Exemplary Embodiment

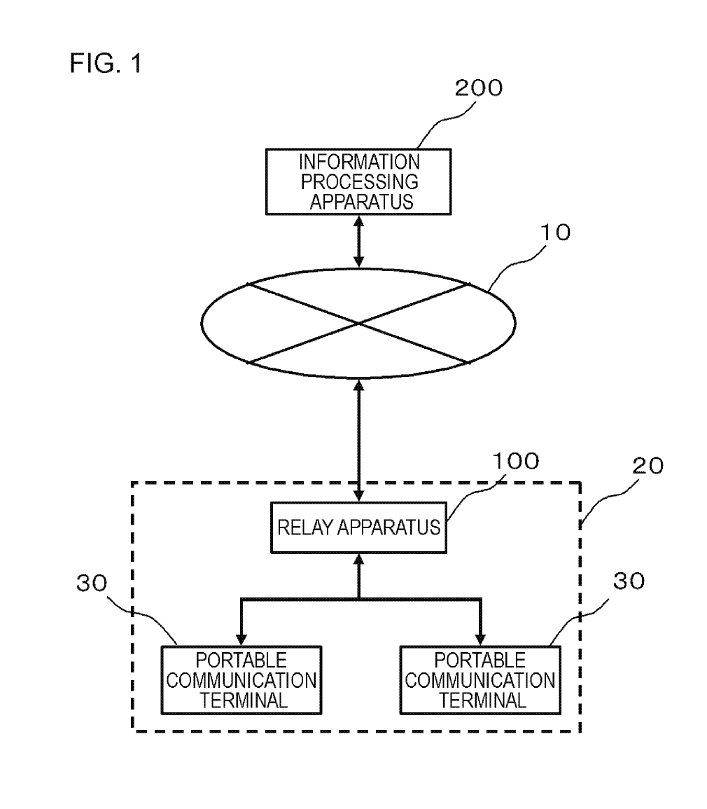

FIG. 1 is a diagram illustrating a configuration of an information processing system according to a first exemplary embodiment. The information processing system includes a relay apparatus 100 and an information processing apparatus 200. The relay apparatus 100 is installed in a moving object 20 gotten on/off by people, and performs communication with portable communication terminals 30. The information processing apparatus 200 performs communication with the relay apparatus 100 through a communication network 10. The relay apparatus 100 and the communication network 10 perform wireless communication with each other. The communication network 10 is a public communication network such as the Internet or a mobile communication network.

The moving object 20 is a vehicle such as a bus or a train gotten on/off by many unspecified people. In addition, the relay apparatus 100 installed in the moving object 20 repeatedly attempts communication with the portable communication terminal 30 carried by a person riding the moving object 20, and transmits information (hereinafter, referred to as terminal identification information) for identifying the portable communication terminal 30 with which the communication can be performed, to the information processing apparatus 200 through the communication network 10.

The information processing apparatus 200 stores the terminal identification information received from the relay apparatus 100. The stored terminal identification information indicates which portable communication terminal 30 is located in a communication range of the relay apparatus 100. On the other hand, in a case where the portable communication terminal 30 is located in a communication range of the relay apparatus 100, an owner of the portable communication terminal 30 can be estimated to be riding the moving object 20. Therefore, the terminal identification information stored in the information processing apparatus 200 is information for specifying a person riding the moving object 20.

In addition, the information processing apparatus 200 repeatedly receives information from the relay apparatus 100 so as to update the stored terminal identification information. Further, the terminal identification information which is deleted during the update is information for specifying a person having left the moving object 20.

As mentioned above, the information processing apparatus 200 manages terminal identification information of a portable communication terminal located in the communication range of the relay apparatus 100, and thus a person who gets on/off the moving object 20 can be specified. In addition, places (for example, stops) where the terminal identification information is added to or deleted from the information processing apparatus 200 are managed, and thus the information processing apparatus 200 can specify positions of a person who has gotten on/off the moving object 20 in real time.

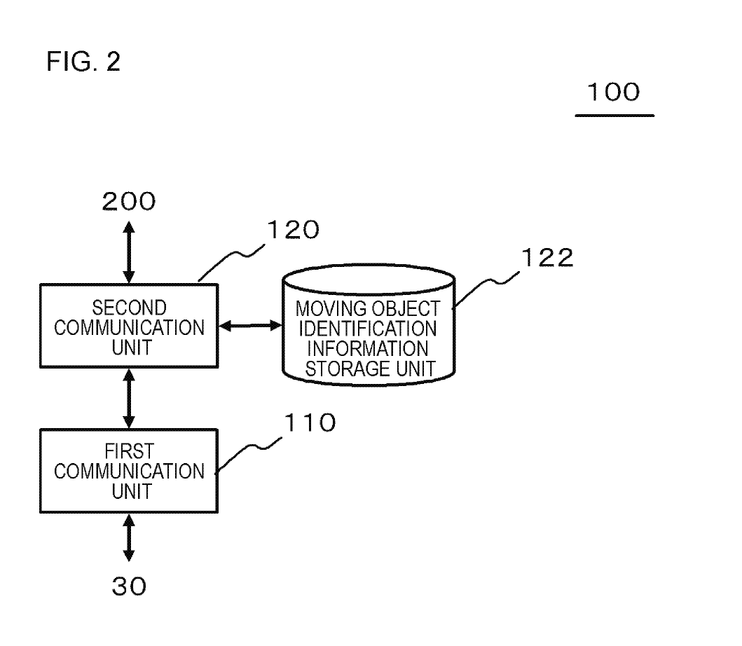

FIG. 2 is a block diagram illustrating a functional configuration of the relay apparatus 100. The relay apparatus 100 includes a first communication unit 110, a moving object identification information storage unit 122, and a second communication unit 120.

The first communication unit 110 repeatedly attempts communication with the portable communication terminals 30 located in the communication range of the relay apparatus 100, and receives, from each of the portable communication terminals 30 with which communication is established, terminal identification information of each of the portable communication terminals 30. The communication between the relay apparatus 100 and the portable communication terminal 30 is performed by using, for example, a wireless LAN (IEEE 802.11) or Bluetooth (registered trademark) (IEEE 802.15.1). In addition, if a communication standard of the wireless LAN is used, the relay apparatus 100 can acquire a media access control (MAC) address of the portable communication terminal 30. In this case, the relay apparatus 100 uses the MAC address as terminal identification information. Further, terminal identification information may be information other than the MAC address. Still further, timing at which the first communication unit 110 attempts communication with the portable communication terminals 30 is right after the moving object departs from a stop or a station, but may be periodic (for example, intervals of one minute).

The moving object identification information storage unit 122 stores information (hereinafter, referred to as a moving object identification information) for identifying the relay apparatus 100 or the moving object 20.

The second communication unit 120 transmits the moving object identification information stored in the moving object identification information storage unit 122 to the information processing apparatus 200 as in-range information along with the terminal identification information received by the first communication unit 110 whenever the first communication unit 110 attempts communication.

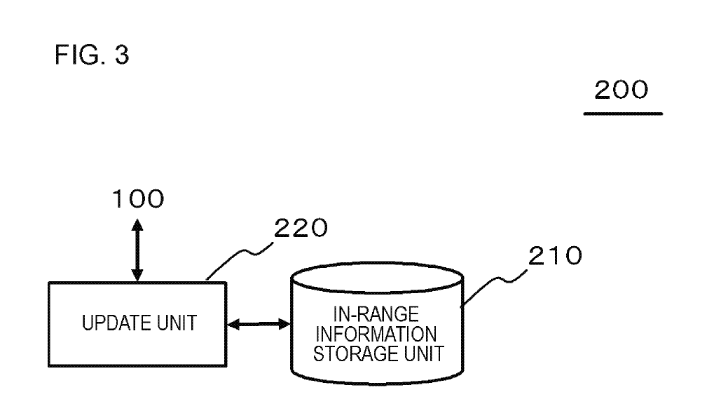

FIG. 3 is a block diagram illustrating a functional configuration of the information processing apparatus 200. The information processing apparatus 200 includes an in-range information storage unit 210 and an update unit 220. The in-range information storage unit 210 stores the in-range information received from the second communication unit 120 of the relay apparatus 100. Specifically, the in-range information storage unit 210 stores terminal identification information on the basis of each piece of moving object identification information. The update unit 220 updates the terminal identification information stored in the in-range information storage unit 210 whenever new in-range information is received from the second communication unit 120. In addition, the in-range information storage unit 210 and the update unit 220 may be different devices in terms of hardware.

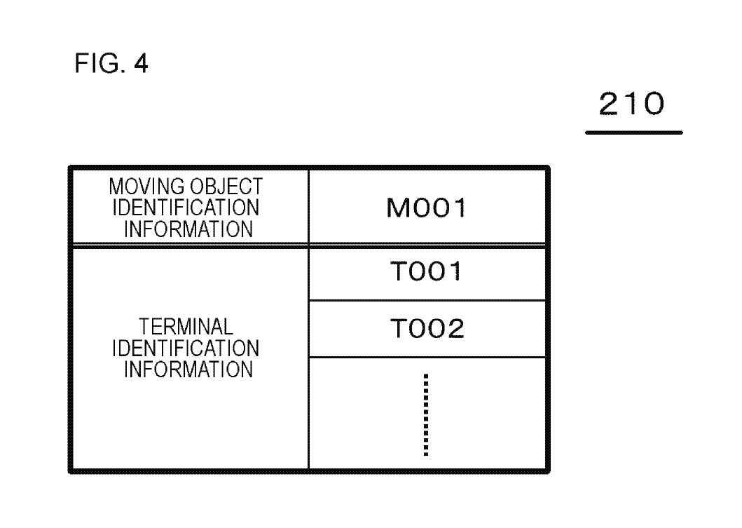

FIG. 4 is a diagram illustrating an example of data stored in the in-range information storage unit 210 in table form. As illustrated in FIG. 4, the in-range information storage unit 210 stores terminal identification information for each piece of moving object identification information.

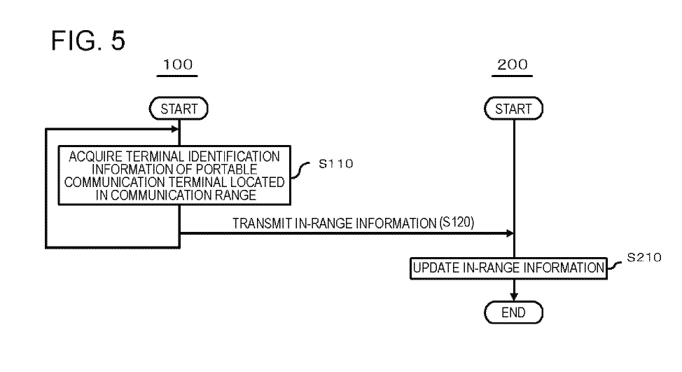

FIG. 5 is a flowchart illustrating an example of operations performed by the relay apparatus 100 and the information processing apparatus 200. The first communication unit 110 of the relay apparatus 100 repeatedly attempts communication with the portable communication terminals 30, and receives terminal identification information of the portable communication terminal 30 located in the communication range of the relay apparatus 100 (step S110). In addition, the second communication unit 120 of the relay apparatus 100 transmits the moving object identification information stored in the moving object identification information storage unit 122 to the information processing apparatus 200 as in-range information along with the terminal identification information received by the first communication unit 110 whenever the first communication unit 110 attempts communication (step S120).

The update unit 220 of the information processing apparatus 200 updates the terminal identification information stored in the in-range information storage unit 210 whenever new in-range information is received from the second communication unit 120 of the relay apparatus 100 (step S210).

As described above, according to the present exemplary embodiment, the in-range information storage unit 210 of the information processing apparatus 200 stores terminal identification information for each piece of moving object identification information. The terminal identification information indicates the portable communication terminal 30 located in the communication range of the relay apparatus 100 installed in the moving object 20 indicated by the moving object identification information, that is, a person who is riding the moving object 20. Therefore, the information processing apparatus 200 can specify a person who is riding the moving object 20.

In addition, the information processing apparatus 200 repeatedly receives information from the relay apparatus 100 so as to update the stored terminal identification information. Further, the information processing apparatus 200 can specify a person who has gotten off the moving object 20 by recognizing terminal identification information which is deleted during the update.

### Second Exemplary Embodiment

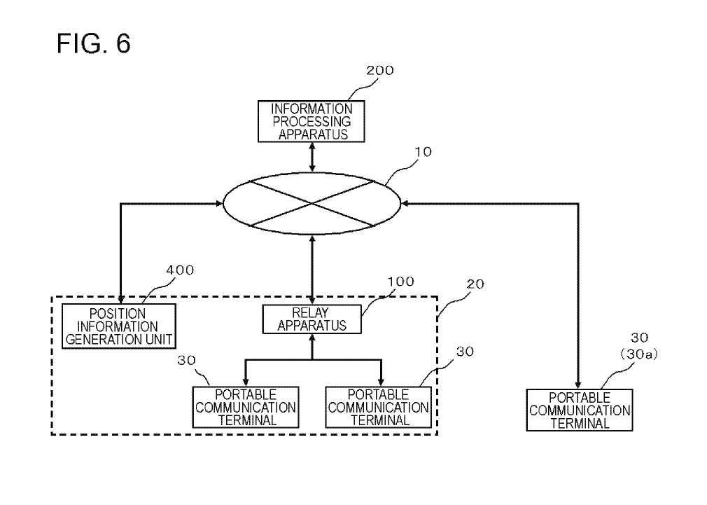

FIG. 6 is a diagram illustrating a configuration of an information processing system according to a second exemplary embodiment. The information processing system illustrated in FIG. 6 has the same configuration as the configuration of the information processing system according to the first exemplary embodiment except for the following configuration.

First, the information processing apparatus 200 transmits information (hereinafter, referred to as provision information) to a portable communication terminal 30 (hereinafter, referred to as a portable communication terminal 30a) which is not located in the communication range of the relay apparatus 100. In addition, it is estimated that a person who owns the portable communication terminal 30a has gotten off the moving object 20. Further, the provision information is, for example, advertisement information of a store located in the vicinity of the position of the moving object where the person gets off. Still further, the provision information may be other information such as a program for providing a service to the user of the portable communication terminal 30a.

In addition, a position information generation unit 400 is installed in the moving object 20. The position information generation unit 400 generates position information of the moving object 20 so as to transmit the position information to the information processing apparatus 200 through the communication network 10. The information processing apparatus 200 uses the position information of the moving object 20 when selecting provision information to be sent to the portable communication terminal 30.

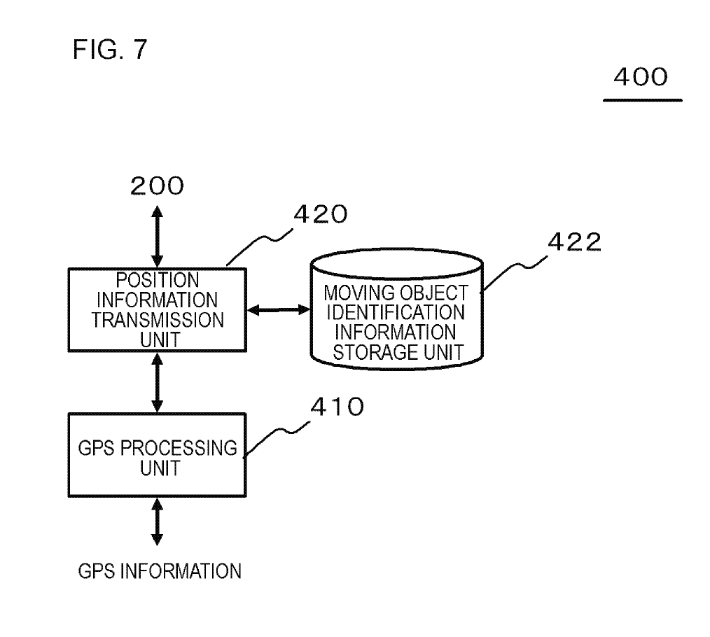

FIG. 7 is a block diagram illustrating an example of a functional configuration of the position information generation unit 400. In the example illustrated in FIG. 7, the position information generation unit 400 includes a GPS processing unit 410, a position information transmission unit 420, and a moving object identification information storage unit 422.

The GPS processing unit 410 receives GPS information from a plurality of global positioning system (GPS) satellites, and generates position information of the moving object 20 by processing the received GPS information. The position information is, for example, information regarding latitude and longitude. The moving object identification information storage unit 422 stores moving object identification information of the moving object 20. In addition, if the GPS processing unit 410 generates the position information, the position information transmission unit 420 reads out moving object identification information from the moving object identification information storage unit 422 and transmits the read out moving object identification information to the information processing apparatus 200 along with the position information generated by the GPS processing unit 410.

In addition, the GPS processing unit 410 generates the position information in a periodic manner (for example, at intervals of one minute). However, the GPS processing unit 410 may generate position information right after the moving object 20 departs from a stop or a station.

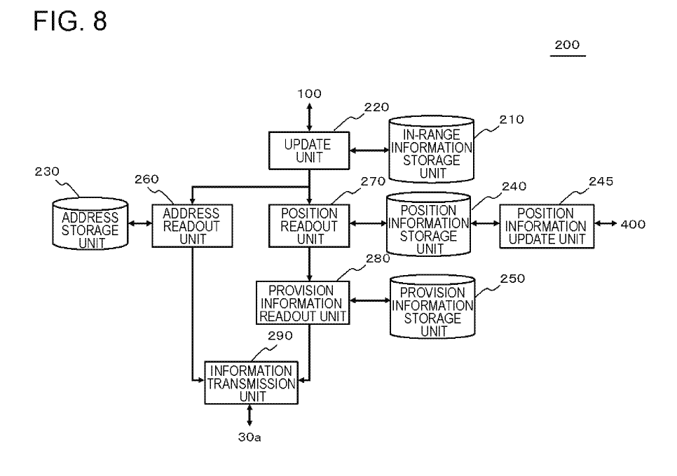

FIG. 8 is a block diagram illustrating a functional configuration of the information processing apparatus 200 according to the present exemplary embodiment. The information processing apparatus 200 includes not only the in-range information storage unit 210 and the update unit 220, but also an address storage unit 230, a position information storage unit 240, a provision information storage unit 250, an address readout unit 260, a position readout unit 270, a provision information readout unit 280, and an information transmission unit 290.

The address storage unit 230 stores an address (for example, an e-mail address) for data communication of the portable communication terminal 30 in correlation with terminal identification information. The position information storage unit 240 stores position information indicating the present position of the moving object 20 in correlation with moving object identification information of the moving object 20. The provision information storage unit 250 stores at least one piece of provision information to be provided to the portable communication terminal 30 in correlation with the position information.

The address readout unit 260 reads out an address corresponding to terminal identification information deleted from the in-range information storage unit 210, from the address storage unit 230 whenever the update unit 220 updates the in-range information storage unit 210. The position readout unit 270 reads out position information corresponding to moving object identification information which corresponds to terminal identification information deleted from the in-range information storage unit 210, from the position information storage unit 240 whenever the update unit 220 updates the in-range information storage unit 210. The provision information readout unit 280 reads out provision information corresponding to the position information read out by the position readout unit 270, from the provision information storage unit 250. In addition, the information transmission unit 290 transmits the provision information read out by the provision information readout unit 280 to the portable communication terminal 30a by using the address read out by the address readout unit 260.

In addition, the address storage unit 230, the position information storage unit 240, and the provision information storage unit 250 may be provided outside the information processing apparatus 200.

In addition, the information processing apparatus 200 also includes a position information update unit 245. The position information update unit 245 repeatedly receives position information and moving object identification information from the position information generation unit 400 installed in the moving object 20. Further, the position information update unit 245 updates the position information stored in the position information update unit 245 by using the received information.

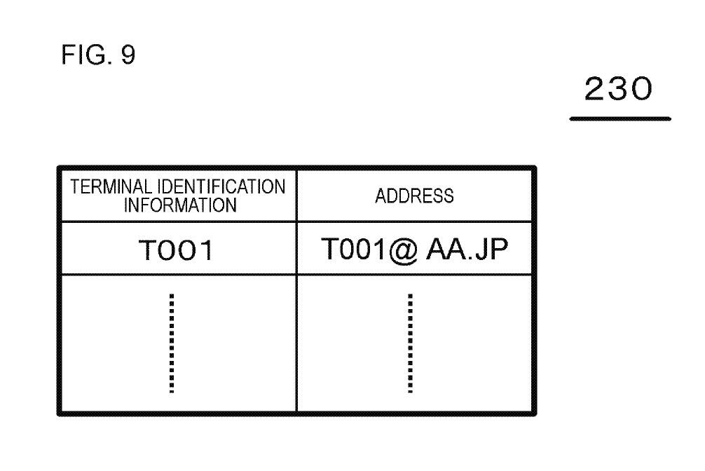

FIG. 9 is a diagram illustrating an example of data stored in the address storage unit 230 in a table form. As illustrated in FIG. 9, the address storage unit 230 stores an address of each of a plurality of portable communication terminals 30 in correlation with terminal identification information (for example, a MAC address) of the portable communication terminal 30. In addition, the address of the portable communication terminal 30 is registered in the address storage unit 230 in advance, for example, by a user of the portable communication terminal 30.

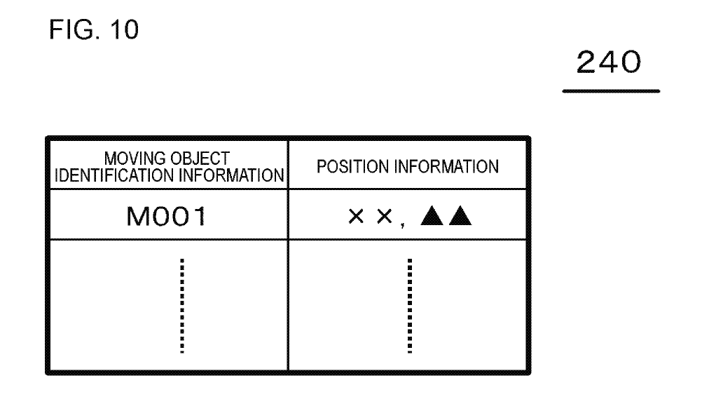

FIG. 10 is a diagram illustrating an example of data stored in the position information storage unit 240 in a table form. As illustrated in FIG. 10, the position information storage unit 240 stores moving object identification information of each of a plurality of moving objects 20 in correlation with position information of the moving object 20.

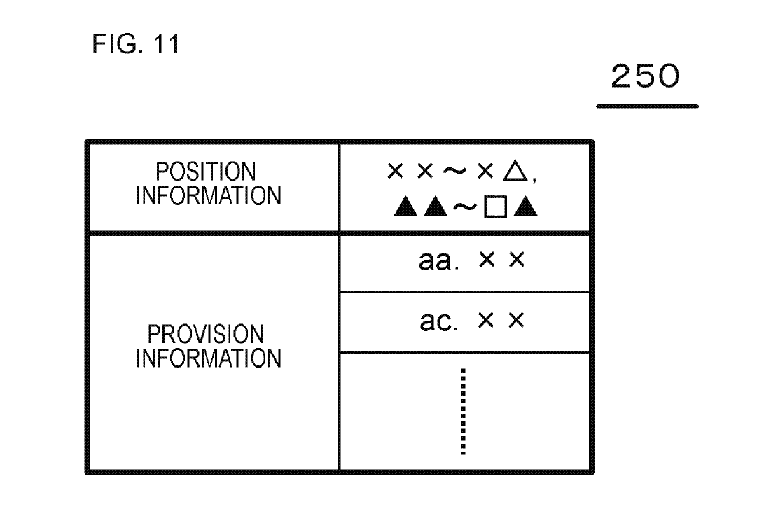

FIG. 11 is a diagram illustrating an example of data stored in the provision information storage unit 250 in a table form. As illustrated in FIG. 11, the provision information storage unit 250 stores at least one piece of provision information for each piece of position information. In the example illustrated in FIG. 11, the provision information storage unit 250 sets a range of numerical values indicated by position information to be wide in advance and manages provision information according to each range (numerical value range). In addition, the provision information readout unit 280 reads out provision information corresponding to a numerical range including provision information which is read out by the position readout unit 270, from the provision information storage unit 250.

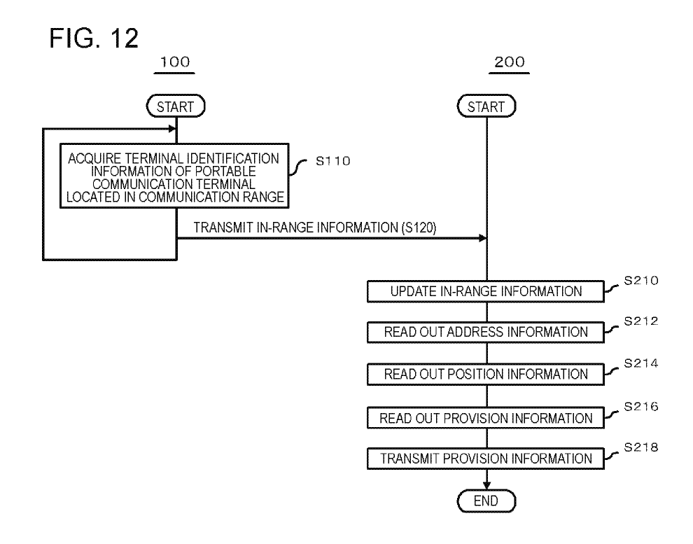

FIG. 12 is a flowchart illustrating examples of operations performed by the relay apparatus 100 and the information processing apparatus 200 according to the present exemplary embodiment. In a process illustrated in FIG. 12, processes up to step S210 are the same as the processes illustrated in FIG. 5. In addition, the position information generation unit 400 operates separately from the flowchart illustrated in FIG. 12. A user authentication process using a MAC address may be performed between step S120 and step S210.

If in-range information is updated, the update unit 220 of the information processing apparatus 200 outputs terminal identification information deleted from the in-range information storage unit 210 to the address readout unit 260, and also outputs moving object identification information to the position readout unit 270. In addition, the address readout unit 260 reads out an address corresponding to the terminal identification information received from the update unit 220, from the address storage unit 230 (step S212). Further, the position readout unit 270 reads out position information corresponding to the moving object identification information received from the update unit 220, from the position information storage unit 240 (step S214).

Still further, the provision information readout unit 280 reads out provision information corresponding to the position information read out by the position readout unit 270, from the provision information storage unit 250 (step S216). Moreover, the information transmission unit 290 transmits the provision information read out by the provision information readout unit 280 to the portable communication terminal 30a by using the address read out by the address readout unit 260 (step S218).

As described above, also in the present exemplary embodiment, it is possible to achieve the same effect as in the first exemplary embodiment. In addition, the information transmission unit 290 of the information processing apparatus 200 can transmit provision information based on the position where a person who is estimated to have gotten off the moving object 20 to the portable communication terminal 30a owned by the person.

Further, the position information update unit 245 of the information processing apparatus 200 repeatedly receives position information and moving object identification information from the position information generation unit 400, and updates the position information storage unit 240 by using the received position information and moving object identification information. Therefore, the information transmission unit 290 can provide more accurate information to the portable communication terminal 30a as provision information.

### Third Exemplary Embodiment

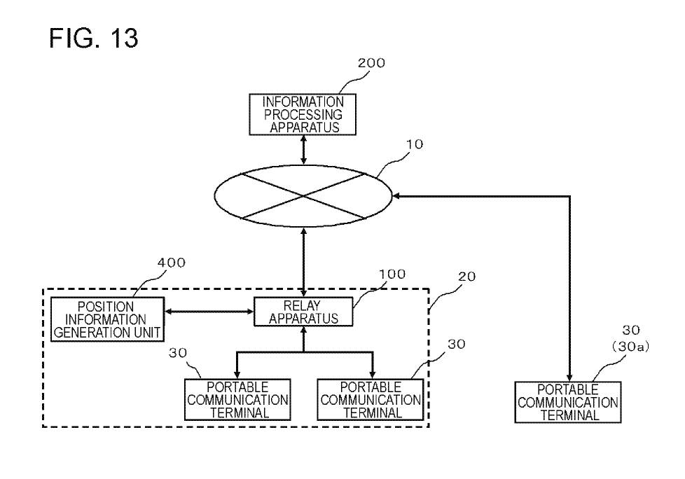

FIG. 13 is a diagram illustrating a configuration of an information processing system according to a third exemplary embodiment. The information processing system according to the present exemplary embodiment has the same configuration as the configuration of the information processing system according to the second exemplary embodiment except for the following configuration.

First, the position information generation unit 400 and the relay apparatus 100 perform communication with each other through a communication line (which may be of either a wired type or a wireless type) provided in the moving object 20. In addition, the position information generation unit 400 transmits generated position information and moving object identification information to the information processing apparatus 200 through the second communication unit 120 of the relay apparatus 100 and the communication network 10.

Further, in the present exemplary embodiment, the position information generation unit 400 may not include the moving object identification information storage unit 422. In this case, the second communication unit 120 of the relay apparatus 100 also reads out moving object identification information from the moving object identification information storage unit 122 and transmits the moving object identification information to the information processing apparatus 200 in a case where position information is transmitted.

Also in the present exemplary embodiment, it is possible to achieve the same effect as in the second exemplary embodiment. In addition, the position information generation unit 400 transmits position information to the information processing apparatus 200 through the relay apparatus 100 and thus may not have a wireless communication function.

### Fourth Exemplary Embodiment

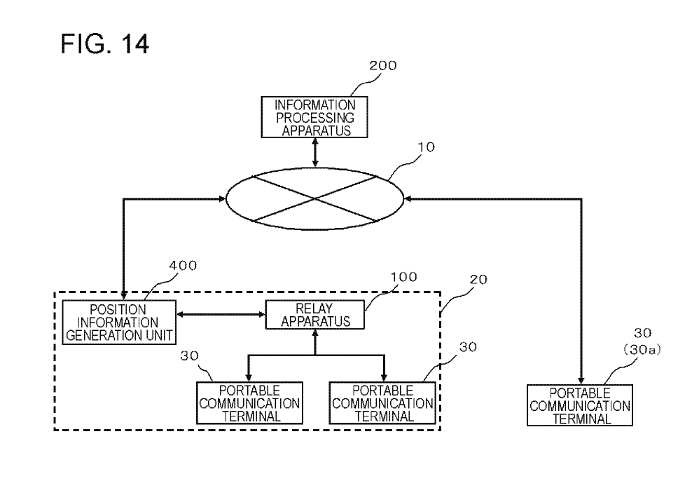

FIG. 14 is a diagram illustrating a configuration of an information processing system according to a fourth exemplary embodiment. The information processing system according to the present exemplary embodiment has the same configuration as the configuration of the information processing system according to the third exemplary embodiment except for the following configuration.

First, the position information generation unit 400 transmits position information and moving object identification information to the information processing apparatus 200 through the communication network 10. On the other hand, the relay apparatus 100 transmits terminal identification information and moving object identification information to the information processing apparatus 200 through the position information generation unit 400 and the communication network 10.

In addition, in the present exemplary embodiment, the relay apparatus 100 may not include the moving object identification information storage unit 122. In this case, the position information transmission unit 420 of the position information generation unit 400 also reads out moving object identification information from the moving object identification information storage unit 422 and transmits the moving object identification information to the information processing apparatus 200 in a case where terminal identification information is transmitted.

Also in the present exemplary embodiment, it is possible to achieve the same effect as in the second exemplary embodiment. In addition, the relay apparatus 100 transmits terminal identification information to the information processing apparatus 200 through the position information generation unit 400 and thus may not have a wireless communication function.

### Fifth Exemplary Embodiment

An information processing system according to the present exemplary embodiment has the same configuration as the configuration of any one of the second to fourth exemplary embodiments except for configurations of the position information generation unit 400 and the information processing apparatus 200.

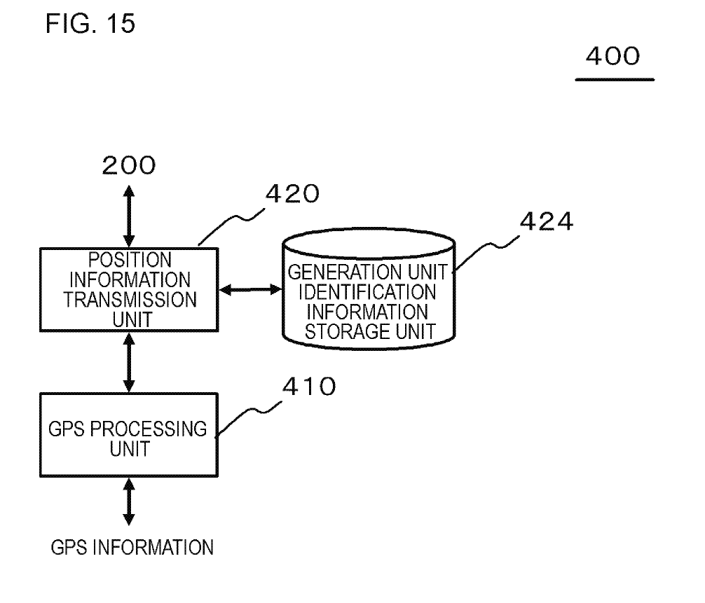

FIG. 15 is a block diagram illustrating a functional configuration of the position information generation unit 400 according to the present exemplary embodiment. The position information generation unit 400 according to the present exemplary embodiment has the same configuration as the configuration of the position information generation unit 400 according to any one of the second to fourth exemplary embodiments except for including a generation unit identification information storage unit 424 instead of the moving object identification information storage unit 422. The generation unit identification information storage unit 424 stores information (hereinafter, referred to as generation unit identification information) for identifying the position information generation unit 400 thereof from other position information generation units 400. In addition, the position information transmission unit 420 transmits the generation unit identification information to the information processing apparatus 200 along with position information instead of moving object identification information.

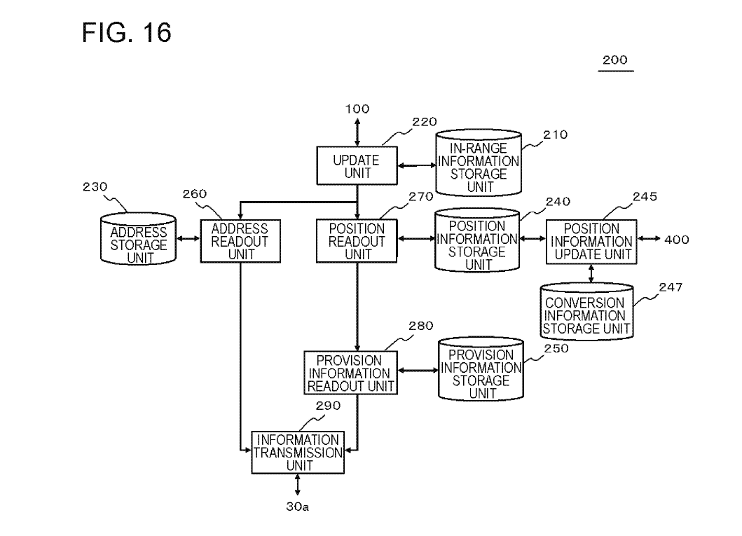

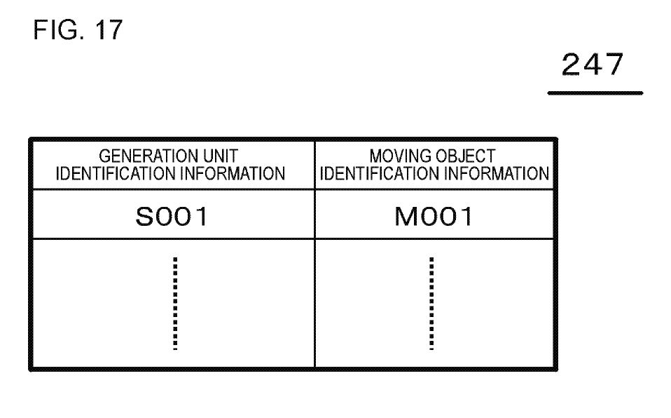

FIG. 16 is a block diagram illustrating a functional configuration of the information processing apparatus 200 according to the present exemplary embodiment. The information processing apparatus 200 according to the present exemplary embodiment has the same configuration as the configuration of the information processing apparatus 200 according to any one of the second to fourth exemplary embodiments except for including a conversion information storage unit 247. As illustrated in a table of FIG. 17, the conversion information storage unit 247 stores a plurality of pieces of generation unit identification information in correlation with moving object identification information of the moving object 20 in which the position information generation unit 400 corresponding to the generation unit identification information is installed.

Also in the present exemplary embodiment, it is possible to achieve the same effect as in the second to fourth exemplary embodiments.

As mentioned above, the exemplary embodiments of the present invention have been described, but the exemplary embodiments are only examples of the present invention, and various configurations other than the exemplary embodiments may be employed.

This application is based upon and claims the benefit of priority from Japanese Patent Application No. 2013-176959, filed Aug. 28, 2013; the entire contents of which are incorporated herein by reference.

1. An information processing system comprising:
a relay apparatus that is installed in a moving object gotten on/off by a person and that performs communication with portable communication terminals; and
an information processing apparatus that performs communication with the relay apparatus,
wherein the relay apparatus includes
a first communication unit that repeatedly attempts communication with the portable communication terminals located in a communication range of the relay apparatus, and receives, from each of the portable communication terminals with which communication is established, terminal identification information for identifying each of the portable communication terminals; and
a second communication unit that transmits moving object identification information for identifying the relay apparatus or the moving object, and the terminal identification information received by the first communication unit, to the information processing apparatus as in-range information, whenever the first communication unit attempts communication, and
wherein the information processing apparatus includes
an in-range information storage unit that stores the in-range information received from the second communication unit; and
an update unit that updates the terminal identification information stored in the in-range information storage unit whenever new in-range information is received from the second communication unit.

2. The information processing system according to claim 1,
wherein the information processing apparatus can be connected to
an address storage unit that stores the terminal identification information in correlation with an address of the portable communication terminal corresponding to the terminal identification information for data communication;
a position information storage unit that stores position information indicating the present position of the moving object in correlation with the moving object identification information of the moving object; and
a provision information storage unit that stores at least one piece of provision information to be provided to the portable communication terminal in correlation with position information, and
wherein the information processing apparatus includes
an address readout unit that reads out the address corresponding to the terminal identification information deleted from the in-range information storage unit from the address storage unit whenever the update unit updates the in-range information storage unit;
a position information readout unit that reads out position information corresponding to the moving object identification information which corresponds to the terminal identification information deleted from the in-range information storage unit, from the position information storage unit whenever the update unit updates the in-range information storage unit;
a provision information readout unit that reads out provision information corresponding to the position information read out by the position information readout unit, from the provision information storage unit; and
an information transmission unit that transmits the provision information read out by the provision information readout unit, by using the address read out by the address readout unit.

3. The information processing system according to claim 2, wherein the information processing apparatus further includes a position information update unit that receives position information indicating the present position of the moving object from the moving object in correlation with the moving object identification information and updates the position information storage unit.

4. The information processing system according to claim 3,
wherein the moving object includes a position information generation unit that generates position information indicating the present position of the moving object and transmits the position information to the position information update unit,
wherein the position information generation unit transmits generation unit identification information for identifying position information generation units from each other to the information processing apparatus along with the generated position information,
wherein the information processing apparatus includes a conversion information storage unit that stores the generation unit identification information in correlation with the moving object identification information, and
wherein the position information update unit reads out the moving object identification information corresponding to the generation unit identification information received from the position information generation unit, from the conversion information storage unit, and updates the position information stored in the position information storage unit by using the read out moving object identification information and the position information received from the position information generation unit.

5. The information processing system according to claim 4, wherein the position information generation unit transmits the generation unit identification information and the generated position information to the information processing apparatus through the relay apparatus.

6. The information processing system according to claim 4, wherein the relay apparatus transmits the in-range information to the information processing apparatus through the position information generation unit.

7. The information processing system according to claim 1, wherein the moving object is a bus or a train.

8. A relay apparatus which is installed in a moving object gotten on/off by a person and which performs communication with portable communication terminals, the apparatus comprising:
a first communication unit that repeatedly attempts communication with the portable communication terminals located in a communication range of the relay apparatus, and receives, from each of the portable communication terminals with which communication is established, terminal identification information for identifying each of the portable communication terminals; and a second communication unit that transmits moving object identification information for identifying the relay apparatus or the moving object, and the terminal identification information received by the first communication unit, to the information processing apparatus as in-range information, whenever the first communication unit attempts communication.

9. An information processing apparatus communicating with a relay apparatus which is installed in a moving object gotten on/off by a person and which performs communication with portable communication terminals, the information processing apparatus comprising:
an in-range information storage unit that stores moving object identification information for identifying the relay apparatus or the moving object, and terminal identification information received by the relay apparatus from the portable communication terminal, as in-range information; and
an update unit that receives new in-range information from the relay apparatus, and updates the terminal identification information stored in the in-range information storage unit whenever the in-range information is received.

10. The information processing apparatus according to claim 9, capable of being connected to
an address storage unit that stores the terminal identification information in correlation with an address of the portable communication terminal corresponding to the terminal identification information for data communication;
a position information storage unit that stores position information indicating the present position of the moving object in correlation with the moving object identification information of the moving object; and
a provision information storage unit that stores at least one piece of provision information to be provided to the portable communication terminal in correlation with position information,
wherein the information processing apparatus includes
an address readout unit that reads out the address corresponding to the terminal identification information deleted from the in-range information storage unit, from the address storage unit whenever the update unit updates the in-range information storage unit;
a position information readout unit that reads out position information corresponding to the moving object identification information which corresponds to the terminal identification information deleted from the in-range information storage unit, from the position information storage unit whenever the update unit updates the in-range information storage unit;
a provision information readout unit that reads out provision information corresponding to the position information read out by the position information readout unit, from the provision information storage unit; and
an information transmission unit that transmits the provision information read out by the provision information readout unit, by using the address read out by the address readout unit.

11. A non-transitory computer readable medium storing a program used for a relay apparatus which is installed in a moving object gotten on/off by a person and which performs communication with portable communication terminals, the program causing the relay apparatus to have:
a first communication function of repeatedly attempting communication with the portable communication terminals located in a communication range of the relay apparatus, and receiving, from each of the portable communication terminals with which communication is established, terminal identification information for identifying each of the portable communication terminals; and a second communication function of transmitting moving object identification information for identifying the relay apparatus or the moving object, and the terminal identification information received by using the first communication function, to the information processing apparatus as in-range information, whenever the relay apparatus attempts communication by using the first communication function.

12. A non-transitory computer readable medium storing a program used for an information processing apparatus communicating with a relay apparatus which is installed in a moving object gotten on/off by a person and which performs communication with portable communication terminals, the program causing the information processing apparatus to have:
an in-range information storage function of storing moving object identification information for identifying the relay apparatus or the moving object, and terminal identification information received by the relay apparatus from the portable communication terminal, as in-range information; and
an update function of receiving new in-range information from the relay apparatus, and updating the terminal identification information stored by using the in-range information storage function whenever the in-range information is received.

13. The non-transitory computer readable medium according to claim 12, the program used for the information processing apparatus which can be can be connected to an address storage unit that stores the terminal identification information in correlation with an address of the portable communication terminal corresponding to the terminal identification information for data communication, a position information storage unit that stores position information indicating the present position of the moving object in correlation with the moving object identification information of the moving object, and a provision information storage unit that stores at least one piece of provision information to be provided to the portable communication terminal in correlation with position information, the program causing the information processing apparatus to further have:
an address readout function of reading out the address corresponding to the terminal identification information deleted by the update function, from information stored in the address storage unit whenever the update function updates the terminal identification information stored in the in-range information storage function;
a position readout function of reading out position information corresponding to the moving object identification information which corresponds to the terminal identification information deleted from the in-range information storage function, from the position information storage unit whenever the update function updates the in-range information storage function;
a provision information readout function of reading out provision information corresponding to the position information read out by the position readout function, from the provision information storage unit; and
an information transmission function of transmitting the provision information read out by the provision information readout function, by using the address which is read out by the address readout function.

14. An information processing method using a relay apparatus that is installed in a moving object gotten on/off by a person and that performs communication with portable communication terminals; and an information processing apparatus that performs communication with the relay apparatus,
wherein the relay apparatus
repeatedly attempts communication with the portable communication terminals located in a communication range of the relay apparatus, and
receives, from each of the portable communication terminals with which communication is established, terminal identification information for identifying each of the portable communication terminals, and transmits the received terminal identification information to the information processing apparatus as in-range information along with moving object identification information for identifying the relay apparatus or the moving object, and
wherein the information processing apparatus stores the in-range information received from the relay apparatus, and updates the stored terminal identification information whenever new in-range information is received from the relay apparatus.
